(19) United States
(12) Patent Application Publication
(10) Pub. No.: US 2021/0174079 A1
(43) Pub. Date: Jun. 10, 2021

(54) METHOD AND APPARATUS FOR OBJECT RECOGNITION

(71) Applicant: Industrial Technology Research Institute, Hsinchu (TW)

(72) Inventors: Li-Pei Wang, Pingtung County (TW); Guan-De Li, Tainan City (TW); Kang-Hao Chaio, Kaohsiung City (TW); Hung-Hsuan Lin, Hsinchu County (TW)

(73) Assignee: Industrial Technology Research Institute, Hsinchu (TW)

(21) Appl. No.: 16/726,825

(22) Filed: Dec. 25, 2019

(30) Foreign Application Priority Data
Dec. 10, 2019 (TW) 108145015

(51) Int. Cl. G06K 9/00; G06K 9/32; G06T 7/11; G06T 7/149

(52) U.S. Cl. CPC G06K 9/00624; G06K 9/3241; G06T 2207/20121; G06T 7/149; G06T 2207/10016; G06T 7/11

(57) ABSTRACT

A method and an apparatus for object recognition are provided. The method includes: receiving a video including a plurality of frames, and separating the frames into a plurality of frame groups; executing object recognition on a specific frame in each of the frame groups to recognize at least one object in the specific frame; dividing a bounded area of each object into a plurality of sub-blocks, and sampling at least one feature point within at least one of the sub-blocks; and tracking each object in the frames in the frame group according to a variation of the feature point in the frames in the frame group.

### CROSS-REFERENCE TO RELATED APPLICATION

This application claims the priority benefit of Taiwan application serial no. 108145015, filed on Dec. 10, 2019. The entirety of the above-mentioned patent application is hereby incorporated by reference herein and made a part of this specification.

### TECHNICAL FIELD

The disclosure relates to a method and an apparatus for image processing, and more particularly to a method and an apparatus for object recognition.

### BACKGROUND

In many fields, there are tasks that require manual monitoring, such as facial recognition performed at self-service immigration control facilities at the airport immigration, waste sorting at resource recycling sites, and recognizing pedestrians and vehicles by using monitors installed by police stations at intersections to check for abnormalities, and the like. Some application fields rely on real-time response results. For example, in the fields such as self-driving cars and self-driving ships, real-time recognition results are required. If a recognition time is shorter, a delay is shorter, and more information is recognized, whereby information for decision-making is more sufficient.

However, high-end photographic equipment today can shoot 120 to 240 frames per second (FPS). To make better use of information captured by a camera, it is important to accelerate a recognition speed in a model.

### SUMMARY

An embodiment of the disclosure provides a method for object recognition, applicable to an electronic apparatus that includes a processor. The method includes: receiving a video including a plurality of frames, and separating the frames into a plurality of frame groups; executing object recognition on a specific frame in each of the frame groups to recognize at least one object in the specific frame; dividing a bounded area of each object into a plurality of sub-blocks, and sampling at least one feature point within at least one of the sub-blocks; and tracking each object in the frames in the frame group according to a variation of the feature point in the frames in the frame group.

An embodiment of the disclosure provides an apparatus for object recognition, including an input/output apparatus, a storage apparatus and a processor. The input/output apparatus is coupled to an image source apparatus and configured to receive a video including a plurality of frames from the image source apparatus. The storage apparatus is configured to store the video received by the input/output apparatus. The processor is coupled to the input/output apparatus and the storage apparatus, and configured to separate the frames in the video into a plurality of frame groups, execute object recognition on a specific frame in each of the frame groups to recognize at least one object in the specific frame, divide a bounded area of each object into a plurality of sub-blocks, and sample at least one feature point within at least one of the sub-blocks, and track the object in the frames in the frame group according to a variation of the feature point in the frames in the frame group.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram of an apparatus for object recognition according to an embodiment of the disclosure.

FIG. 2 is a flowchart of a method for object recognition according to an embodiment of the disclosure.

FIG. 3 is a schematic diagram of grouping frames according to an embodiment of the disclosure.

FIG. 4A and FIG. 4B are schematic diagrams of sampling feature points according to an embodiment of the disclosure.

FIG. 5 is a schematic diagram of object tracking according to an embodiment of the disclosure.

FIG. 6A and FIG. 6B are schematic diagrams of object tracking according to an embodiment of the disclosure.

### DETAILED DESCRIPTION OF DISCLOSED EMBODIMENTS

According to characteristics that objects in continuous images move little in a short period of time and have similar features and that most images applied in actual fields are highly continuous, embodiments of the disclosure increase recognition speed by using an object recognition and optical flow method in view of similarity of continuous images. An object recognition model in an embodiment of the disclosure is a deep learning object recognition model, and a large number of images are input into a training model as training data to learn and determine categories and positions of objects in each of the images.

In an embodiment of the disclosure, for example, a sparse optical flow method is used together with an object recognition model. According to variations of pixels of continuous frames, movement speed and direction of an object are inferred, and acceleration is accomplished. The sparse optical flow method needs only to track a small number of feature points in the image. Therefore, required computing resources are far less than those required in conventional object recognition. In an embodiment of the disclosure, high-accuracy detection provided by an object recognition technology works together with a small computing load and high-speed prediction available from the sparse optical flow method to keep recognition accuracy and improve object recognition speed.

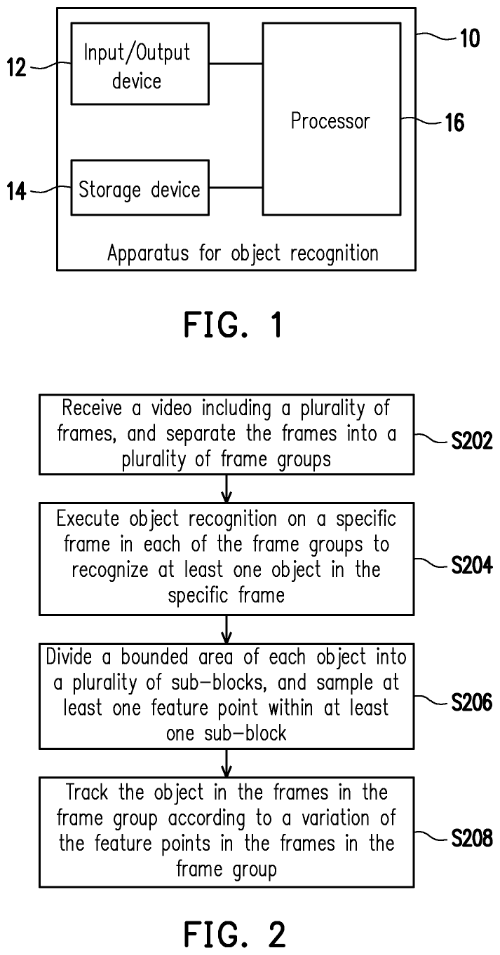

FIG. 1 is a block diagram of an apparatus for object recognition according to an embodiment of the disclosure. Referring to FIG. 1, an apparatus 10 for object recognition in this embodiment is, for example, a camera, a camcorder, a mobile phone, a personal computer, a server, a virtual reality device, an augmented reality device, or another device, each having a computing function. The apparatus 10 for object recognition includes at least an input/output (I/O) device 12, a storage device 14, and a processor 16, whose functions are described below.

The input/output device 12 is, for example, a wired or wireless communication interface such as a universal serial bus (USB), an RS232, a Bluetooth (BT), or a wireless fidelity (Wi-Fi) interface, and is used to receive videos provided by image source devices such as cameras and camcorders. In an embodiment, the input/output device 12 may also include a network adapter that supports Ethernet or a wireless network standard such as 802.11g, 802.11n, and 802.11ac. In this way, the apparatus 10 for object recognition can be coupled to a network and receive videos through a remote device such as a network camera or a cloud server.

In an embodiment, the apparatus 10 for object recognition may include one of the image source devices, or may be built in the image source device. The input/output device 12 is a bus disposed inside the apparatus for transmitting data, and can transmit a video to a processor 16 for processing, where the video is shot by the image source device. This embodiment is not limited to the foregoing architecture.

The storage device 14 is, for example, any type of fixed or removable random access memory (RAM), read-only memory (ROM), flash memory, hard disk, or a similar component or a combination thereof, and is used to store a program executable by the processor 16. In an embodiment, the storage device 14 further stores, for example, a video received by the input/output device 12 from the image source device.

The processor 16 is coupled to the input/output device 12 and the storage device 14, and may be, for example, a central processing unit (CPU), or another programmable general-purpose or special-purpose microprocessor, a digital signal processor (DSP), a programmable controller, an application-specific integrated circuit (ASIC), a programmable logic controller (PLC) or another similar device or a combination thereof, and can load and execute the program stored in the storage device 14 to execute the method for object recognition in the embodiment of the disclosure.

FIG. 2 is a flowchart of a method for object recognition according to an embodiment of the disclosure. Referring to both FIG. 1 and FIG. 2, the method in this embodiment is applicable to the apparatus 10 for object recognition. The following describes detailed steps of the method for object recognition in this embodiment with reference to components of the apparatus 10 for object recognition.

First, in step S202, the processor 16 uses the input/output device 12 to receive a video including a plurality of frames from an image source device, and divides the received frames into a plurality of frame groups. The number of frames included in each frame group is, for example, dynamically determined by the processor 16 according to characteristics of a shooting scene, object recognition requirements, or computing resources of the apparatus, and is not limited to a fixed number of frames.

In step S204, the processor 16 executes object recognition on a specific frame in each of the frame groups to recognize at least one object in the specific frame. In an embodiment, the processor 16 may, for example, execute an object recognition algorithm on a first frame in each of the frame groups to recognize an object in the first frame. The processor 16 may, for example, use a pre-created object recognition model to find features in the frame and recognize the object. The object recognition model is, for example, a model created by using a convolutional neural network (CNN), a deep learning algorithm, or another type of artificial intelligence (AI) algorithm, and learns a large number of input images to recognize or distinguish different features in the image.

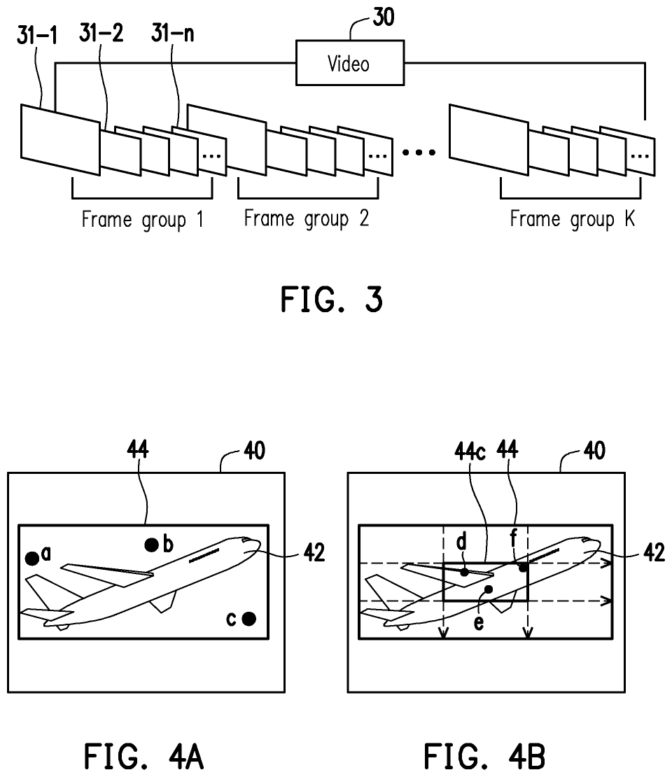

For example, FIG. 3 is a schematic diagram of grouping frames according to an embodiment of the disclosure. Referring to FIG. 3, in this embodiment, a plurality of frames in the received video 30 are divided into frame groups 1 to K, and object recognition is performed on the first frame in each frame group to obtain information such as a coordinate, size, or category of target object and obtain a bounded area available for bounding the object. For example, for frames 31-1 to 31-n in a frame group 1, this embodiment performs object recognition on the first frame 31-1, and tracks a variation of the recognized object in subsequent frames 31-2 to 31-n.

Referring back to the flow in FIG. 2, in step S206, the processor 16 divides a bounded area of each object into a plurality of sub-blocks, and samples at least one feature point in at least one sub-block. In an embodiment, the bounded area is, for example, a smallest rectangle that can cover a target object. In other embodiments, the bounded area may be but without limitation an area of another shape or size as required. The number of the sub-blocks obtained through division, the number of feature points sampled in each sub-block, and/or the position of each feature point may be dynamically determined by the processor 16 according to characteristics of the shooting scene, object recognition requirements, object characteristics, or computing resources of the apparatus, and is not limited to a fixed number.

In an embodiment, the processor 16 may, for example, divide the bounded area of each object into a plurality of equal sub-blocks (for example, nine rectangle sub-blocks), and select a sub-block for sampling feature points, where the sub-block is a sub-block that covers a largest area of the object among the sub-blocks (such as a central sub-block located at a center). In an embodiment, the method for dividing a bounded area and/or the number of sub-blocks are determined according to the characteristics of the object. For example, a stripe-shaped bounded area is divided into three equal or non-equal sub-blocks. In an embodiment, a sub-block in which the feature points need to be sampled is determined according to the characteristics of the object. For example, if the object is a donut, the feature points may be sampled in another sub-block other than a central sub-block of the nine rectangle sub-blocks.

For example, FIG. 4A and FIG. 4B are schematic diagrams of sampling feature points according to an embodiment of the disclosure. In this embodiment, an object 42 in a frame 40 is detected by using an object recognition method, so as to find a bounded area 44 of the object 42. FIG. 4A shows a result of directly sampling feature points in the bounded area 44. Because the feature points a to c are not located on the object 42, if the object 42 is tracked by using the feature points a to c, an inferior or incorrect result may be obtained. FIG. 4B shows a result of dividing the bounded area 44 into nine equal sub-blocks and sampling feature points in the central sub-block 44c. The central sub-block 44c generally covers a relatively large area of the object 42, and all feature points d to f sampled in the central sub-block 44c fall on the object 42. Therefore, if the object 42 is tracked by using the feature points d to f, tracking results may be relatively accurate.

In step S208, the processor 16 tracks the object in the frames in the frame group according to a variation of the feature points in the frames in the frame group. Specifically, for example, the processor 16 randomly samples a plurality of optical flow tracking points in the sub-block selected in step S206, uses the optical flow tracking points as feature points, and uses a sparse optical flow method to track variations of the optical flow tracking points in subsequent frames, and to track objects within the frame. The sparse optical flow method may be, for example but without limitation, a Lucas-Kanade optical flow method.

According to the method described above, this embodiment uses an object recognition technology to select a target object, tracks the feature points of continuous images, calculates the variation of the selected object between the continuous images, thereby keeping recognition accuracy and improving object recognition speed.

It should be noted that, in other embodiments, the processor 16 may, for example, according to the average displacement of the optical flow tracking points in the frame and the change of intervals between the tracking points, change the sub-block used to track the object, or change the position or size of the bounded area of the object, which is not limited herein.

In an embodiment, the processor 16 may, for example, calculate an average displacement of each feature point within the sub-block, select a neighboring sub-block in the average displacement to replace the current sub-block, and re-sample at least one feature point within the neighboring sub-block for tracking. The average displacement is, for example, an average of distances of all the feature points in all directions, and may represent a movement trend of the object. In this embodiment, by diverting the tracked block to the movement direction of the object, subsequent changes in the position of the object can be accurately tracked.

In an embodiment, the processor 16 may, for example, calculate the average displacement of each feature point within the sub-block, and change the position of the bounded area of the object according to the calculated average displacement. In this embodiment, by moving the position of the bounded area of the tracked object toward the calculated average displacement and sampling and tracking feature points again in the moved bounded area, subsequent position change of the object can be tracked accurately.

In an embodiment, for example, the processor 16 calculates the change of interval between the feature points, and changes the size of the bounded area of the object according to a difference in the calculated change of interval. Specifically, when the size of the object in the frame changes (increases or decreases) due to moving (closer or farther away), the change of interval between corresponding feature points on the object also changes, and the change of interval change is somehow in proportion to the size change of the object. Therefore, in this embodiment, by appropriately enlarging or reducing the size of the bounded area of the tracked object according to the difference in the calculated change of interval and sampling and tracking feature points again in the enlarged or reduced bounded area, subsequent position change of the object can be tracked accurately.

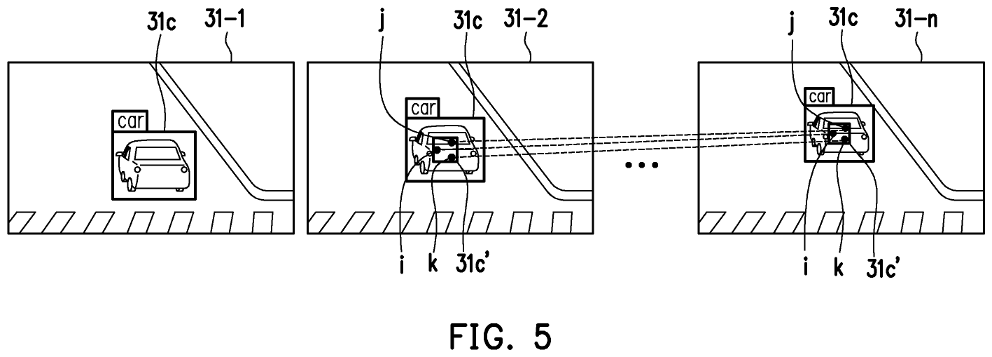

For example, FIG. 5 is a schematic diagram of object tracking according to an embodiment of the disclosure. Referring to FIG. 3 and FIG. 5, in this embodiment, object recognition and tracking are performed on a plurality of frames 31-1 to 31-n in a frame group 1 in FIG. 3. By performing object recognition on the first frame 31-1, an object “car” can be recognized, and a bounded area 31c of the object “car” can be found. By randomly sampling feature points in the bounded area 31c (for example, feature points i, j, and k in a central sub-block 31c′ of the bounded area 31c in the frame 31-2), and by calculating variations of the feature points i, j, and k within the frames 31-1 to 31-n, the object “car” can be tracked continuously. According to an average displacement of the feature points i, j, and k, movement of the object “car” can be recognized, and the position of the bounded area 31c can be appropriately adjusted. According to the difference in the change of interval between the feature points i, j, and k, the size change of the object “car” can be recognized, and the size of the bounded area 31c can be appropriately adjusted. As shown in FIG. 5, during the process from a frame 31-2 to a frame 31-n, according to the change of the feature points i, j, and k, the bounded area 31c in the frame 31-n is moved upward and reduced in size in comparison with the bounded area 31c in the frame 31-2.

In an embodiment, when a plurality of objects exist in the frame, the objects may overlap. The object overlap may affect accuracy of object recognition and tracking. In this regard, in the foregoing embodiments of the disclosure, each object in the frame has been recognized to generate a bounded area, and feature points for tracking the object are generated in the bounded area. Therefore, in an embodiment, the feature points may be combined with the bounded area to avoid the foregoing impact caused by object overlap.

Specifically, in an embodiment, the apparatus for object recognition may, for example, determine whether a bounded area of an object in the frame overlaps another. When it is determined that a bounded area overlaps, the apparatus for object recognition uses the feature points originally sampled in the sub-block to which each object belongs, and excludes the feature points sampled in the sub-block to which other objects belong (that is, other feature points are not included in the calculation) to track each object. For example, when a first object and a second object are recognized in a specific frame, the apparatus for object recognition determines whether the bounded area of the first object overlaps the bounded area of the second object. When the bounded area of the first object overlaps the bounded area of the second object, the apparatus for object recognition uses the feature points sampled in the first object and excludes the feature points sampled in the second object to track the first object.

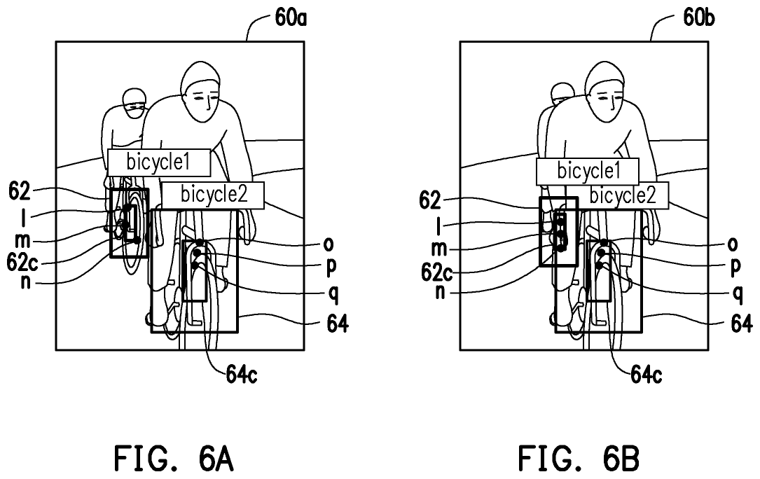

For example, FIG. 6A and FIG. 6B are schematic diagrams of object tracking according to an embodiment of the disclosure. Referring to FIG. 6A first, assuming that objects bicycle1 and bicycle2 have been recognized in the frame 60a so that a bounded area 62 corresponding to the object bicycle1 and a bounded area 64 corresponding to the object bicycle2 are generated, feature points l, m, and n are randomly sampled in a central sub-block 62c of the bounded area 62, and feature points o, p, and q are randomly sampled in a central sub-block 64c of the bounded area 64 for tracking. Referring to FIG. 6B, over time, the objects bicycle1 and bicycle2 in the frame 60b have been moved so that the bounded areas 62 and 64 overlap, and the feature points l, m and n previously located in the bounded area 62 enter the bounded area 64. If the feature points l, m, n are taken into account in recognizing and tracking the object bicycle 2 at this time, accuracy of the recognition may be affected. In an embodiment, the feature points l, m, and n are bound to the bounded area 62, and the feature points o, p, and q are bound to the bounded area 64. When the bounded areas 62 and 64 overlap, only the feature points in the original bounded area instead of other feature points are used in calculation for recognizing the objects in the bounded areas. This avoids the impact caused by the overlap of the bounded areas to accuracy of object recognition and tracking.

The method and apparatus for object recognition according to an embodiment of the disclosure divides frames of a video into a plurality of groups, performs object recognition on only at least one frame in each group, and randomly generates sparse optical flow tracking points in the bounded area of the recognized object; for the remaining frames in the group, adjusts the position and size of the bounded area of the object according to the variation of the sparse optical flow tracking points. In this way, object tracking is performed and the effect of accelerating object recognition is achieved.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for object recognition, applicable to an electronic apparatus that comprises a processor, wherein the method comprises:
receiving a video comprising a plurality of frames, and separating the frames into a plurality of frame groups;
executing object recognition on a specific frame in each of the frame groups to recognize at least one object in the specific frame;
dividing a bounded area of each of the at least one object into a plurality of sub-blocks, and sampling at least one feature point within at least one sub-block of the sub-blocks; and
tracking the at least one object in the frames in the frame group according to a variation of the at least one feature point in the frames in the frame group.

2. The method according to claim 1, wherein executing object recognition on the specific frame in each of the frame groups to recognize the at least one object in the specific frame comprises:
executing object recognition on a first frame in each of the frame groups to recognize the at least one object in the first frame.

3. The method according to claim 1, wherein sampling the at least one feature point within the at least one sub-block of the sub-blocks comprises:
sampling the at least one feature point within a central sub-block located at a center of the sub-blocks.

4. The method according to claim 1, wherein sampling the at least one feature point within the at least one sub-block of the sub-blocks and the tracking the at least one object in the frames in the frame group according to the variation of the at least one feature point in the frames in the frame group comprise:
sampling a plurality of optical flow tracking points randomly in the at least one sub-block of the sub-blocks as the at least one feature point; and
using a sparse optical flow method to track a variation of the optical flow tracking points in the frames in the frame group, to track the at least one object in the frames in the frame group.

5. The method according to claim 1, wherein sampling the at least one feature point within the at least one sub-block of the sub-blocks comprises:
calculating an average displacement of the at least one feature point within the sub-block; and
selecting a neighboring sub-block in the average displacement to replace a current sub-block, and re-sampling the at least one feature point within the neighboring sub-block for tracking.

6. The method according to claim 1, wherein tracking the at least one object in the frames in the frame group according to the variation of the at least one feature point in the frames in the frame group comprises:
calculating an average displacement of the feature point; and
changing a position of the bounded area of the object according to the calculated average displacement.

7. The method according to claim 1, wherein tracking the at least one object in the frames in the frame group according to the variation of the at least one feature point in the frames in the frame group comprises:
calculating a change of interval between the at least one feature point; and
changing a size of the bounded area of the at least one object according to a difference in the calculated change of interval.

8. The method according to claim 1, wherein the at least one object comprises a first object and a second object, and the tracking the at least one object in the frames in the frame group according to the variation of the at least one feature point in the frames in the frame group comprises:
determining whether a bounded area of the first object overlaps a bounded area of the second object; and
when the bounded area of the first object overlaps the bounded area of the second object, using the at least one feature point sampled in the first object and excluding the at least one feature point sampled in the second object to track the first object.

9. The method according to claim 1, wherein the bounded area of each of the at least one object is a smallest rectangle that can cover the at least one object.

10. The method according to claim 1, wherein sampling the at least one feature point within the at least one sub-block of the sub-blocks comprises:
among the sub-blocks, selecting the at least one sub-block with a largest area covering the at least one object to sample the at least one feature point.

11. The method according to claim 1, wherein sampling the at least one feature point within the at least one sub-block of the sub-blocks comprises:
determining, according to characteristics of the at least one object, a sub-block in which the at least one feature point is sampled.

12. An apparatus for object recognition, comprising:
an input/output apparatus, coupled to an image source apparatus and configured to receive a video comprising a plurality of frames from the image source apparatus;
a storage apparatus, configured to store the video received by the input/output apparatus; and
a processor, coupled to the input/output apparatus and the storage apparatus, and configured to separate the frames in the video into a plurality of frame groups, execute object recognition on a specific frame in each of the frame groups to recognize at least one object in the specific frame, divide a bounded area of each of the at least one object into a plurality of sub-blocks, and sample at least one feature point within at least one sub-block of the sub-blocks, and track the at least one object in the frames in the frame group according to a variation of the at least one feature point in the frames in the frame group.

13. The apparatus for object recognition according to claim 12, wherein the processor executes object recognition on a first frame in each of the frame groups to recognize the at least one object in the first frame.

14. The apparatus for object recognition according to claim 12, wherein the processor samples the at least one feature point within a central sub-block located at a center of the sub-blocks.

15. The apparatus for object recognition according to claim 12, wherein the processor samples a plurality of optical flow tracking points randomly in the at least one sub-block of the sub-blocks as the at least one feature point, and uses a sparse optical flow method to track a variation of the optical flow tracking points in the frames in the frame group, to track the at least one object in the frames in the frame group.

16. The apparatus for object recognition according to claim 12, wherein the processor calculates an average displacement of the at least one feature point within the sub-block, selects a neighboring sub-block in the average displacement to replace a current sub-block, and re-samples the at least one feature point within the neighboring sub-block for tracking.

17. The apparatus for object recognition according to claim 12, wherein the processor calculates an average displacement of the at least one feature point, and changes a position of the bounded area of the at least one object according to the calculated average displacement.

18. The apparatus for object recognition according to claim 12, wherein the processor calculates a change of interval between the at least one feature point, and changes a size of the bounded area of the at least one object according to a difference in the calculated change of interval.

19. The apparatus for object recognition according to claim 12, wherein the at least one object comprises a first object and a second object, and the processor determines whether a bounded area of the first object overlaps a bounded area of the second object, and when the bounded area of the first object overlaps the bounded area of the second object, the processor uses the at least one feature point sampled in the first object and excludes the at least one feature point sampled in the second object to track the first object.
